(19) United States
(12) Patent Application Publication
(10) Pub. No.: US 2024/0326728 A1
(43) Pub. Date: Oct. 3, 2024

(54) POWER SUPPLY DEVICE AND MOTORIZED DEVICE

(71) Applicant: MINEBEA MITSUMI Inc., Nagano (JP)

(72) Inventors: Shinji TANAKA, Nagano (JP); Atsushi KIKUCHI, Nagano (JP)

(21) Appl. No.: 18/573,722

(22) PCT Filed: Jun. 28, 2022
(86) PCT No.: PCT/JP2022/025712

§ 371 Date: Dec. 22, 2023

(30) Foreign Application Priority Data
Jun. 30, 2021 (JP) 2021-108417

(51) Int. Cl. B60R 16/033; E05F 15/611; H02J 7/00

(52) U.S. Cl. CPC B60R 16/033; E05F 15/611; H02J 7/00711; H02J 7/007182; E05Y 2900/531; H02J 2207/20

(57) ABSTRACT

A power supply device includes an electrical storage device and a bidirectional buck-boost converter having a charging function of starting charging of the electrical storage device based on input power from a power system of a vehicle, upon occurrence of a condition in which a voltage of the electrical storage device decreases to a first threshold and of stopping the charging of the electrical storage device, upon occurrence of a condition in which the voltage of the electrical storage device increases to a second threshold that is greater than the first threshold. The bidirectional buck-boost converter has a boost function of stepping up the voltage of the electrical storage device. The power supply device includes a control circuit configured to cause the boost circuit to perform a boost operation such that a boosted voltage that is higher than the voltage of the electrical storage device is supplied to a load device, and such that the boosted voltage is a constant voltage.

### TECHNICAL FIELD

The present disclosure relates to a power supply device and a motorized device.

### BACKGROUND

For latch mechanisms of doors in vehicles such as automobiles, electric latching systems that release a latch by using electric actuators have been adopted. In a normal state, a main power supply in a vehicle supplies the voltage to the electric actuator. However, a door of the vehicle is required to be released even in an emergency such as an accident. For this reason, in many cases, the electric latching system includes an auxiliary power supply to enable the electric actuator to continuously operate for a certain time period after power supplied by the main power supply to the electric actuator is interrupted in the emergency such as an accident.

### RELATED-ART DOCUMENT

### Patent Document

Patent Document 1: Japanese Patent No. 6527467

### SUMMARY

### Problem to be Solved by the Invention

However, when the voltage of the main power supply or the auxiliary power supply varies, a voltage to be supplied to a load device such as an motorized actuator may vary.

The present disclosure provides a power supply device capable of suppressing variations in a voltage to be supplied to a load device, and provides a motorized device including the power supply device.

In one aspect of the present disclosure, a power supply device is provided. The power supply device includes an electrical storage device; a charging circuit configured to start charging of the electrical storage device based on input power from a power system of a vehicle, upon occurrence of a condition in which a voltage of the electrical storage device decreases to a first threshold, and stop the charging of the electrical storage device, upon occurrence of a condition in which the voltage of the electrical storage device increases to a second threshold, the second threshold being greater than the first threshold; a boost circuit configured to step up the voltage of the electrical storage device; and a control circuit configured to cause the boost circuit to perform a boost operation such that, a boosted voltage that is higher than the voltage of the electrical storage device is supplied to a load device, and such that the boosted voltage is a constant voltage.

### Effects of the Invention

In one aspect of the present disclosure, variations in a voltage to be supplied to a load device can be suppressed.

### BRIEF DESCRIPTION OF DRAWINGS

FIG. 1 is a diagram illustrating a configuration example of a motorized device including a power supply device according to a first embodiment.

FIG. 2 is a timing chart illustrating an operation example of the power supply device according to the first embodiment.

FIG. 3 is a diagram illustrating a configuration example of the motorized device including the power supply device according to a second embodiment.

FIG. 4 is a timing chart illustrating an operation example of the power supply device according to the second embodiment.

FIG. 5 is a diagram illustrating a configuration example of the motorized device including the power supply device according to a third embodiment.

FIG. 6 is a timing chart illustrating an operation example of the power supply device according to the third embodiment.

FIG. 7 is a diagram illustrating a configuration example of the motorized device including the power supply device according to a fourth embodiment.

FIG. 8 is a timing chart illustrating an operation example of the power supply device according to the fourth embodiment.

FIG. 9 is a table that summarizes operation examples according to the embodiments.

### DESCRIPTION OF EMBODIMENTS

Embodiments are described below.

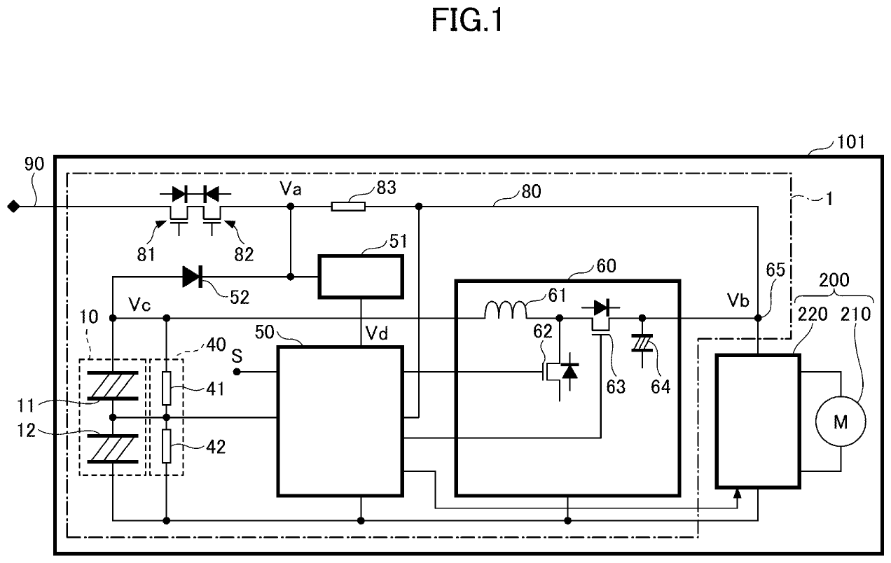

FIG. 1 is a diagram illustrating a configuration example of a motorized device including a power supply device according to a first embodiment. A motorized device 101 illustrated in FIG. 1 is a device that is mounted on a vehicle such as an automobile, and that operates a load device 200 based on input power from a power system 90 of the vehicle. The power system 90 includes, for example, a main power supply (for example, a DC battery of 12 V) that is mounted on the vehicle, and includes a power supply harness that couples the main power supply to a power supply terminal of the motorized device 101. The main power supply may be a converter.

The motorized device 101 includes the load device 200 and a power supply device 1.

The load device 200 is a device that controls the operation of vehicle equipment (for example, an opening-and-closing member such as a door) that is operated by a user, and the load device 200 operates by DC power that is supplied by the power supply device 1. The load device 200 includes a drive circuit 220 and a load 210. The drive circuit 220 is a driver that operates by the DC power supplied by the power supply device 1, and the drive circuit 220 drives the load 210. The load 210 is a device capable of controlling the operation of the vehicle equipment to be operated by the user. The load 210 is, for example, a motor. When the load 210 is the motor, an H-bridge circuit or the like is used as a specific example of the drive circuit 220.

The motorized device 101 is, for example, an electric latching device that releases a latch by using an electric actuator, and the latch is a mechanical lock mechanism for an opening-and-closing member such as a door of the vehicle. The opening-and-closing member such as the door of the vehicle is an example of the vehicle equipment that is operated by the user. The opening-and-closing member is opened and closed by a user's operation that is performed through a door handle, a remote controller, a contact sensor, a non-contact sensor, or the like. When the motorized device 101 is the electric latching device, the load 210 is, for example, a motor in an electric actuator that releases the latch.

The motorized device 101 is not limited to the electric latching device. The motorized device 101 may include an electric brake device that performs braking of a brake mechanism in the vehicle by using an electric actuator. The brake mechanism is an example of vehicle equipment that is operated by the user, and is actuated by the user operation that is performed through a brake pedal or the like. The motorized device 101 may include an electric retractor device that winds up a seat belt of the vehicle by using a powered motor. The seat belt is an example of vehicle equipment that is operated by the user, and is fastened or unfastened by a user operation.

The power supply device 1 generates the power to be supplied to the load device 200, based on the power supplied from the power system 90. The power supply device 1 includes an electrical storage device 10 that stores the power supplied from the power system 90 such that the power can be continuously supplied to the load device 200 for a certain time period after the power supplied from the power system 90 is interrupted.

The power supply device 1 includes the electrical storage device 10, an equalization circuit 40, a power path 80, a bidirectional buck-boost converter 60, a regulator 51, a diode 52, and a control circuit 50.

The electrical storage device 10 is a device that stores electricity. The electrical storage device 10 includes at least one cell (in this example, two cells 11 and 12 coupled in series). Each of the cells 11 and 12 is an element that stores power, and is, for example, an electric double-layer capacitor (what is called a supercapacitor). The electrical storage device 10 may be a secondary battery such as a nickel-hydrogen battery.

The equalization circuit 40 performs an equalization process (a process of equalizing voltages that are applied to the respective cells 11 and 12) for the electrical storage device 10. In this example, the equalization circuit 40 includes resistors 41 and 42 that are coupled in series. The resistance of the resistor 41 is the same as the resistance of the resistor 42. The resistor 41 is an element that is coupled in parallel to the cell 11, and the resistor 42 is an element that is coupled in parallel to the cell 12.

The power path 80 is a line with one end coupled to the power system 90 and the other end coupled to an output node 65-side of the bidirectional buck-boost converter 60. In this example, a backflow prevention circuit 81, an overcurrent prevention circuit 82, and a resistor 83 are inserted in the power path 80 to be coupled in series. The backflow prevention circuit 81 prevents the current from flowing back from the output node 65 toward the power system 90, due to a reverse connection or the like of the main power supply. The overcurrent prevention circuit 82 prevents overcurrent from the power system 90 into the output node 65.

The bidirectional buck-boost converter 60 has a boost function of stepping up a voltage Vc of the electrical storage device 10 and outputting a voltage Vb that is higher than the voltage Vc to the output node 65, and also has a buck function of stepping down the voltage Vb of the output node 65 and outputting the voltage Vc that is lower than the voltage Vb to the electrical storage device 10. With use of the boost function, the electrical storage device 10 can be discharged, and thus Vb (also referred to as a “boosted voltage”) that is higher than the voltage Vc of the electrical storage device 10 can be supplied as a supply voltage for the load device 200. With use of the buck function, the electrical storage device 10 can be charged with a voltage that is lower than the voltage Vb at the output node 65. That is, the bidirectional buck-boost converter 60 is a bidirectional DC-DC converter in which a boost circuit that steps up the voltage Vc of the electrical storage device 10 and a charging circuit that charges the electrical storage device 10 are integrated. The bidirectional buck-boost converter 60 may have any known circuit configuration. In this example, the bidirectional buck-boost converter 60 includes an inductor 61, switching elements 62 and 63, and a smoothing capacitor 64. Each of the switching elements 62 and 63 is, for example, a semiconductor element. A specific example of the switching element is a metal oxide semiconductor field effect transistor (MOSFET) having a parasitic diode.

The regulator 51 is a circuit that generates a supply voltage Vd to the control circuit 50 based on the power supplied from either the power system 90 or the electrical storage device 10. With this arrangement, even after the power supplied from the power system 90 is interrupted, the regulator 51 can generate the supply voltage Vd to the control circuit 50 based on the power supplied from the electrical storage device 10. Further, by providing the regulator 51, even when a voltage Va supplied from the power system 90 or the voltage Vc of the electrical storage device 10 varies, the supply voltage Vd to the control circuit 50 can be maintained constant.

The regulator 51 generates the supply voltage Vd to the control circuit 50, for example, based on a higher voltage (strictly, in consideration of a forward voltage of the diode 52) of the voltage Va input from the power system 90 and the voltage Vc of the electrical storage device 10. The regulator 51 is, for example, a low dropout regulator.

The diode 52 is an element in which an anode is coupled to an output side of the electrical storage device 10 and a cathode is coupled to an input side of the regulator 51. The diode 52 can prevent backflow of the current from the power path 80 toward the electrical storage device 10.

The control circuit 50 causes the bidirectional buck-boost converter 60 to perform a boost operation such that the voltage Vb that is higher than the voltage Vc of the electrical storage device 10 is supplied to the load device 200, and such that the supplied voltage Vb is a constant voltage. The control circuit 50 performs a feedback control in which the switching of the switching element 62 is performed, for example, such that the voltage Vb of the output node 65 is maintained at a predetermined constant voltage. With this arrangement, the constant voltage Vb can be supplied to the drive circuit 220 of the load device 200.

The control circuit 50 causes the bidirectional buck-boost converter 60 to perform a charging operation such that the electrical storage device 10 is charged based on the power that is input from the output node 65 via the power path 80. The control circuit 50 performs the switching of the switching element 63 to cause the bidirectional buck-boost converter 60 to perform the charging operation. For example, when the voltage Vc of the electrical storage device 10 decreases to a first threshold Vth1, the control circuit 50 causes the bidirectional buck-boost converter 60 to perform the charging operation, and when the voltage Vc increases to a second threshold Vth2, the control circuit 50 stops the charging operation of the bidirectional buck-boost converter 60. With this arrangement, even when the voltage Va that is input from the power system 90 varies due to a load change that occurs in a case or the like where an engine starts, a variation range of the voltage Vc of the electrical storage device 10 can be suppressed to be greater than or equal to the first threshold Vth1 and less than or equal to the second threshold Vth2.

The second threshold Vth2 is set to a value that is greater than the first threshold Vth1. The second threshold Vth2 is set to be lower than the voltage Va from the power system 90, when the voltage Va is obtained in a normal state. For example, in the normal state, when the voltage Va is in the range of 9 V to 16 V, the second threshold Vth2 is set, for example, to about 5 V, and the first threshold Vth1 is set to about 3 V.

The control circuit 50 acquires an operation detection signal S indicating a state in which vehicle equipment is operated by the user. When the motorized device 101 is the electric latching device, the operation detection signal S indicates the presence or absence of a user operation for a door handle, a remote controller, a contact sensor, a non-contact sensor, or the like.

The control circuit 50 is, for example, a microcomputer that includes a memory and a processor such as a central processing unit (CPU). A function of the control circuit 50 is implemented by the processor that operates in accordance with a program that is stored in the memory. The function of the control circuit 50 may be implemented by a field programmable gate array (FPGA) or an application specific integrated circuit (ASIC).

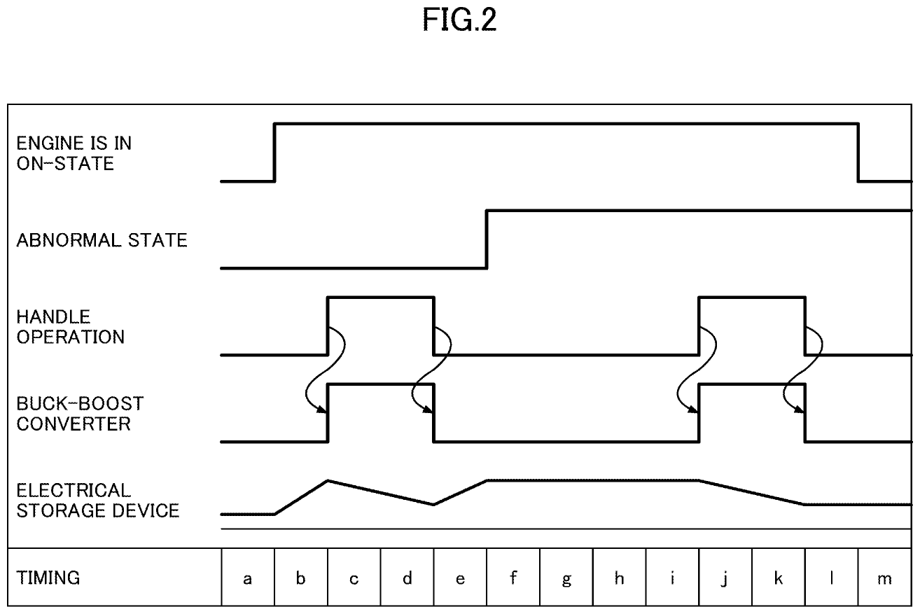

FIG. 2 is a timing chart illustrating an operation example of the power supply device according to the first embodiment. An abnormal state refers to a state in which power supplied from the power system 90 to the motorized device 101 is interrupted due to a failure or the like of the power system 90; or a state in which an emergency signal that is obtained in a case where a collision or the like of the vehicle is detected is issued in an emergency such as an accident. In FIG. 2, the abnormal state is held during a high-level period (the same state applies to other timing charts described below). At timings a, b, c, d, and e, the normal state is held. At timings f, g, h, i, j, k, l, and m, the abnormal state is held.

In the first embodiment, if vehicle equipment such as a door is being operated, the control circuit 50 causes the bidirectional buck-boost converter 60 to perform the boost operation. In contrast, if the vehicle equipment such as a door is not being operated, the control circuit 50 stops the boost operation of the bidirectional buck-boost converter 60. For example, in response to receiving the operation detection signal S indicating that the vehicle equipment such as a door is being operated, the control circuit 50 causes the bidirectional buck-boost converter 60 to perform the boost operation, regardless of whether the normal state or the abnormal state is held (without monitoring the emergency signal).

If the operation of the vehicle equipment is detected based on the operation detection signal S, the control circuit 50 may start the boost operation of the bidirectional buck-boost converter 60. In contrast, if a predetermined stop condition is satisfied after the operation of the vehicle equipment is detected, the control circuit 50 may stop the boost operation of the bidirectional buck-boost converter 60. The predetermined stop condition includes, for example, a condition in which either a state in which the operation of the vehicle equipment is stopped or a state in which the operation of the vehicle equipment is regarded as being stopped is detected, and also includes a condition or the like in which a predetermined time period has elapsed after the operation of the vehicle equipment is detected. The predetermined stop condition may include a condition in which detection of the vehicle equipment operating based on the operation detection signal S is stopped.

In the first embodiment, regardless of whether the vehicle equipment is being operated, the control circuit 50 determines whether to cause the bidirectional buck-boost converter 60 to perform a buck operation (charging operation) in accordance with the magnitude of the voltage Vc of the electrical storage device 10 that is obtained while the engine is on (during operation). If the voltage Vc of the electrical storage device 10 decreases to the first threshold Vth1, the control circuit 50 causes the bidirectional buck-boost converter 60 to perform the charging operation, and if the voltage Vc increases to the second threshold Vth2, the control circuit 50 causes the bidirectional buck-boost converter 60 to stop the charging operation.

For example, when the voltage Vc of the electrical storage device 10 decreases to the first threshold Vth1 due to continuous operation or the like of the vehicle equipment, even in a case where the operation of the vehicle equipment is detected based on the operation detection signal S, the control circuit 50 may forcibly start the charging operation of the bidirectional buck-boost converter 60.

At a timing b, upon the start or the like of the engine in the vehicle, power is input from the power system 90, and thus the power supply device 1 starts. If the voltage Vc is lower than the first threshold Vth1, the control circuit 50 operates the bidirectional buck-boost converter 60 as a buck converter (charging circuit), and thus the control circuit 50 charges the electrical storage device 10 until the voltage Vc increases to the second threshold Vth2. The voltage Vc of the electrical storage device 10 gradually increases by the charging operation.

At timings c and d, upon detecting the operation of vehicle equipment such as a door based on the operation detection signal S, the control circuit 50 operates the bidirectional buck-boost converter 60 as a boost converter (boost circuit), for which the electrical storage device 10 is used as a power supply. The control circuit 50 causes the bidirectional buck-boost converter 60 to perform the boost operation such that a higher voltage Vb than the voltage Vc of the electrical storage device 10 is supplied to the load device 200, and such that the supplied voltage Vb is a constant voltage. With this approach, variations in the voltage Vb supplied to the load device 200 can be suppressed. The voltage Vc of the electrical storage device 10 gradually decreases by the boost operation.

At a timing e, a predetermined stop condition is satisfied after the operation of the vehicle equipment such as a door is detected, and thus the control circuit 50 stops the boost operation of the bidirectional buck-boost converter 60. When the voltage Vc is decreased to a first threshold Vth, the control circuit 50 operates the bidirectional buck-boost converter 60 as a buck converter such that the electrical storage device 10 is charged. When the voltage Vc increases to the second threshold Vth2, the control circuit 50 stops the charging operation of the bidirectional buck-boost converter 60.

At timings f, g, h, and i, the abnormal state is held. During such a time period, the voltage Vc is higher than the first threshold Vth1 (it is not decreased to the first threshold Vth1), and thus the operation of the vehicle equipment such as a door is not detected based on the operation detection signal S. In this case, the control circuit 50 stops the charging operation and the boost operation of the bidirectional buck-boost converter 60.

At timings i and k, upon detecting the operation of the vehicle equipment such as a door based on the operation detection signal S, the control circuit 50 operates the bidirectional buck-boost converter 60 as the boost converter (boost circuit), for which the electrical storage device 10 is used as a power supply. The control circuit 50 causes the bidirectional buck-boost converter 60 to perform the boost operation such that a higher voltage Vb than the voltage Vc of the electrical storage device 10 is supplied to the load device 200, and such that the supplied the voltage Vc is a constant voltage. With this arrangement, variations in the voltage Vb to be supplied to the load device 200 can be suppressed. The voltage Vc of the electrical storage device 10 gradually decreases by the boost operation.

At a timing 1, a predetermined stop condition is satisfied after the operation of the vehicle equipment such as a door is detected, the control circuit 50 stops the boost operation of the bidirectional buck-boost converter 60. When the voltage Vc is not decreased to the first threshold Vth, the control circuit 50 maintains a stop state of the boost operation, without operating the bidirectional buck-boost converter 60 as the buck converter. With this approach, the voltage Vc of the electrical storage device 10 is maintained constant.

As described above, in the first embodiment, the control circuit 50 causes the bidirectional buck-boost converter 60 to perform the boost operation such that a higher boosted voltage than the voltage Vc of the electrical storage device 10 is supplied to the load device 200, and such that the supplied boosted voltage is a constant voltage, regardless of whether a failure of the power system 90 or an emergency state occurs. With this arrangement, even when the voltage of the power system 90 or the electrical storage device 10 varies, a constant voltage can be supplied to the load device 200.

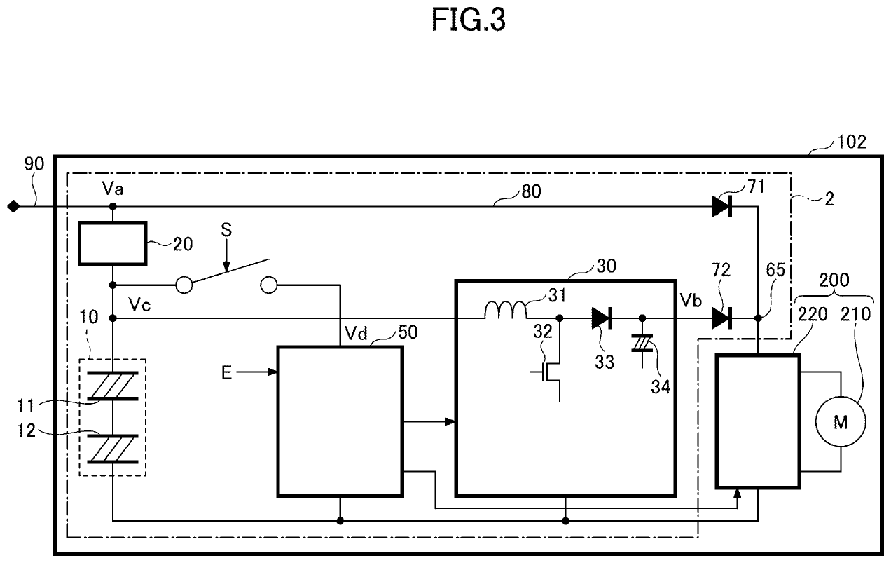

FIG. 3 is a diagram illustrating a configuration example of the motorized device with the power supply device according to a second embodiment. In the second embodiment, description for the same configuration, operation, and effects as described in the first embodiment will be omitted or simplified by incorporating the above description.

A motorized device 102 illustrated in FIG. 3 includes a power supply device 2 and the load device 200. The power supply device 2 differs from that in the first embodiment in that the power supply device 2 includes diodes 71 and 72, a charging circuit 20, and a boost circuit 30. That is, the power supply device 2 according to the second embodiment is not a buck-boost converter in which a charging circuit (buck circuit) and a boost circuit are integrated, and the power supply device 2 includes the charging circuit (buck circuit) and the boost circuit separately.

The components illustrated in FIG. 1 (the backflow prevention circuit 81, the overcurrent prevention circuit 82, the resistor 83, the equalization circuit 40, the regulator 51, and the diode 52) are not illustrated in FIG. 3. However, the power supply device 2 according to the second embodiment may include a portion or all of these components (the same configuration applies to the other embodiments described below)

In FIG. 3, the diode 71 is inserted in the power path 80, and prevents backflow from the output node 65 toward the power system 90. The diode 72 prevents backflow from the output node 65 toward the boost circuit 30. The diodes 71 and 72 constitute a diode-OR circuit.

A diode 33 is present in the boost circuit 30, and thus the diode 72 may be omitted. The presence of the diode 72 can protect a smoothing capacitor 34 in the boost circuit 30 from overvoltage. Even when the diode 72 is not provided, in a case where input power from the power system 90 is interrupted, a power path to the load device 200 is automatically switched from a path that uses the power path 80 to a path that uses the boost circuit 30.

The charging circuit 20 has a buck function (charging function) of stepping down the voltage Va supplied from the power system 90 and charging the electrical storage device 10 based on a lower voltage Vc than the voltage Va. When the voltage Vc of the electrical storage device 10 decreases to the first threshold Vth1, the charging circuit 20 starts the charging of the electrical storage device 10 based on the input power from the power system 90. In contrast, when the voltage Vc of the electrical storage device 10 increases to the second threshold Vth2 that is higher than the first threshold Vth1, the charging circuit 20 stops the charging of the electrical storage device 10. The charging circuit 20 itself may monitor the voltage Vc to perform the charging operation alone without receiving a command from the control circuit 50, or may perform the charging operation in accordance with the command from the control circuit 50. The charging circuit 20 may have any known circuit configuration.

The boost circuit 30 has a boost function of stepping up the voltage Vc of the electrical storage device 10 and outputting a higher voltage Vb than the voltage Vc to the output node 65. The boost circuit 30 may have any known circuit configuration. In this example, the boost circuit 30 includes an inductor 31, a switching element 32, the diode 33, and the smoothing capacitor 34. The switching element 32 is, for example, a semiconductor element, and a specific example of the switching element 32 is a MOSFET having a parasitic diode.

The control circuit 50 constantly operates the boost circuit 30 such that the voltage Vb is lower than the voltage Va of the power path 80. With this arrangement, in the normal state, power can be supplied from the power system 90 to the load device 200 via the power path 80.

In the second embodiment, the control circuit 50 acquires (monitors) an emergency signal E that is obtained in a case where a collision or the like of the vehicle is detected. The control circuit 50 may acquire (monitor) the operation detection signal S indicating a state in which the vehicle equipment is being operated by a user.

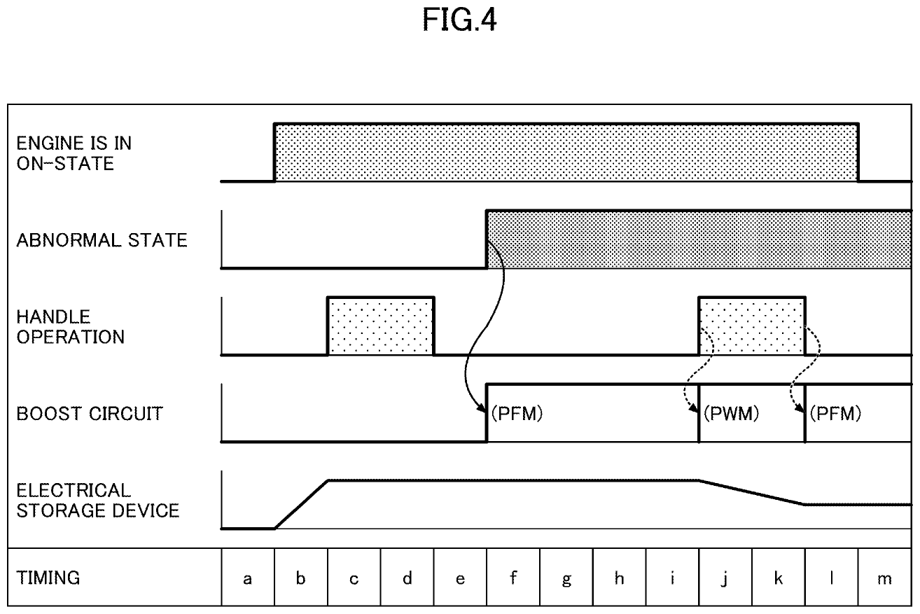

FIG. 4 is a timing chart illustrating an operation example of the power supply device according to the second embodiment.

In the second embodiment, the control circuit 50 constantly operates the boost circuit 30 such that the voltage Vb is lower than the voltage Va of the power path 80. In this arrangement, in the normal state, power can be supplied from the power system 90 to the load device 200 via the power path 80. With this approach, operating power that the load device 200 generates upon the vehicle equipment being operated in the normal state (at the timings c and d) is covered by the power supplied from the power system 90 via the power path 80. The voltage Vc of the electrical storage device 10 is maintained.

In the second embodiment, at the timing f, upon detecting an abnormality in the vehicle based on the emergency signal E, the control circuit 50 starts the boost operation of the boost circuit 30 such that the current flows from the boost circuit 30 into the load device 200. When the abnormality in the vehicle is detected based on the emergency signal E, the control circuit 50 operates the boost circuit 30 intermittently or in a PFM operating mode, and when the operation of vehicle equipment is detected at the timing j, based on the operation detection signal S, the control circuit 50 causes the boost circuit 30 to switch to a PWM operating mode. The control circuit 50 may cause the boost circuit 30 to switch from the PWM operating mode to either an intermittent operation or the PFM operating mode, when the predetermined stop condition is satisfied at the timing 1 after the operation of the vehicle equipment such as a door is detected. The control circuit 50 may continue to operate the boost circuit 30 intermittently or in the PFM operating mode, even after the timing m at which the engine is stopped.

The intermittent operation or the pulse frequency modulation (PFM) operating mode can improve boosting efficiency at a time of a light load, by reducing a switching frequency in a unit time. The PWM (pulse wide modulation) operating mode can improve the boosting efficiency at a time of a medium load to a high load. With this arrangement, by operating the boost circuit 30 intermittently or in the PFM operating mode, power that is consumed during a time period required to detect the operation of the vehicle equipment after the detecting of the abnormality can be suppressed. Thus, the PWM operating mode can be enabled even when power consumption of the load device 200 is increased due to the operation of the vehicle equipment.

In the second embodiment, the boost circuit 30 is being operated at the timing f before the timing j at which the operation of the vehicle equipment is detected. This can shorten a waiting time period (for example, from the operating of the door to the releasing of a given latch) until the load device 200 moves after the vehicle equipment operates.

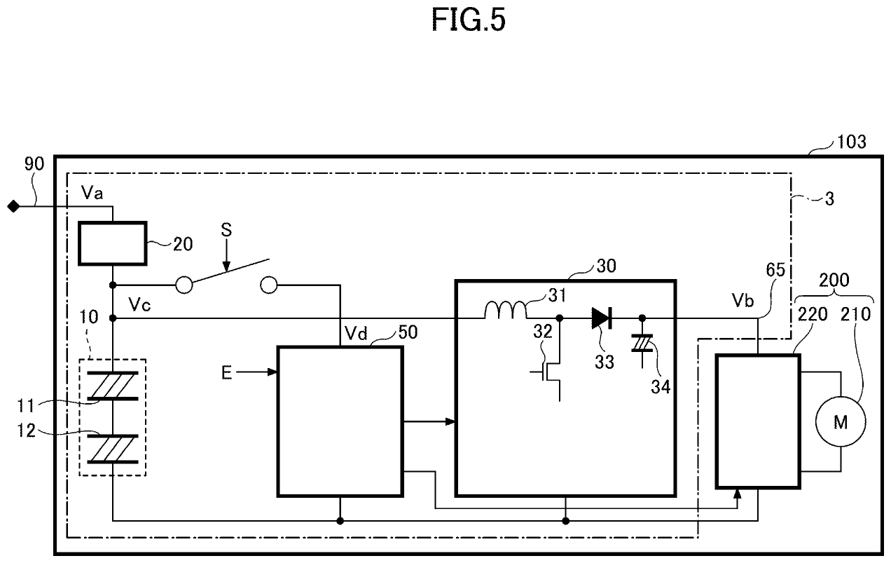

FIG. 5 is a diagram illustrating a configuration example of the motorized device with the power supply device according to a third embodiment. In the third embodiment, description for the same configuration, operation, and effects as described in the first and second embodiments will be omitted or simplified by incorporating the above description.

A motorized device 103 illustrated in FIG. 5 includes a power supply device 3 and the load device 200. The power supply device 3 differs from that described the first embodiment, in that the power supply device 3 includes the charging circuit 20 and the boost circuit 30 but does not include the power path 80.

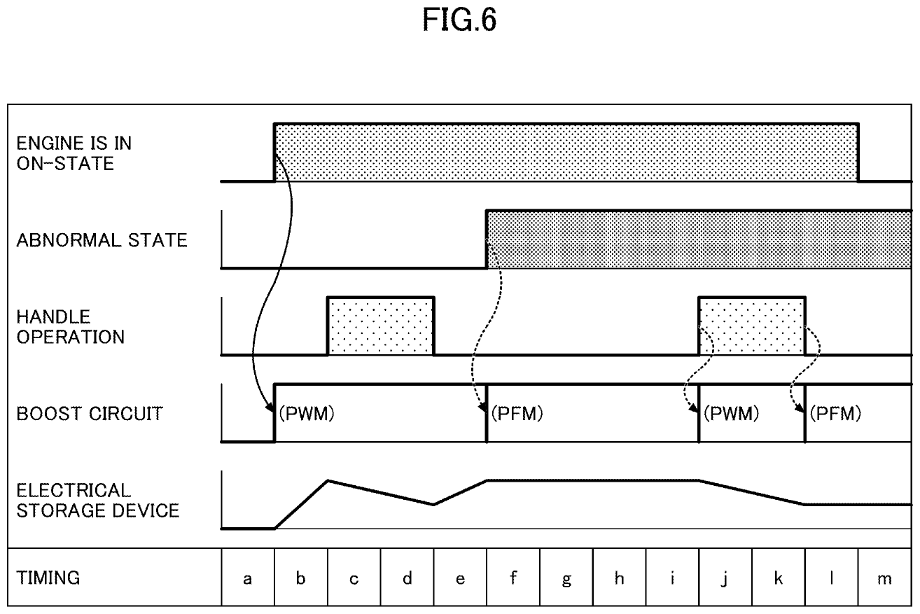

FIG. 6 is a timing chart illustrating an operation example of the power supply device according to the third embodiment. In the third embodiment, the current constantly flows from the boost circuit 30 into the load device 200, in both the normal state and the abnormal state.

In the third embodiment, the control circuit 50 starts the boost circuit 30 immediately after the power is input from the power system 90, and then causes the boost circuit 30 to constantly perform the boost operation such that the current continuously flows from the boost circuit 30 into the load device 200. When the control circuit 50 causes the boost circuit 30 to perform the boost operation such that the current flows from the boost circuit 30 into the load device 200, in a case where an abnormality in the vehicle is detected at the timing f based on the emergency signal E, the control circuit 50 changes the boost operation of the boost circuit 30 to either the intermittent operation or the PFM operating mode. When the operation of the vehicle equipment is detected based on the operation detection signal S, the control circuit 50 causes the boost circuit 30 to switch to the PWM operating mode. With this approach, even when the power input from the power system 90 is interrupted, an instance of instantaneous interruption that occurs when switching the power supply from the power system 90 to the electrical storage device 10 can be eliminated. Further, by switching to the intermittent operation or the PFM operating mode when detecting the abnormality, increasing power that is consumed until the operation of the vehicle equipment is detected can be suppressed.

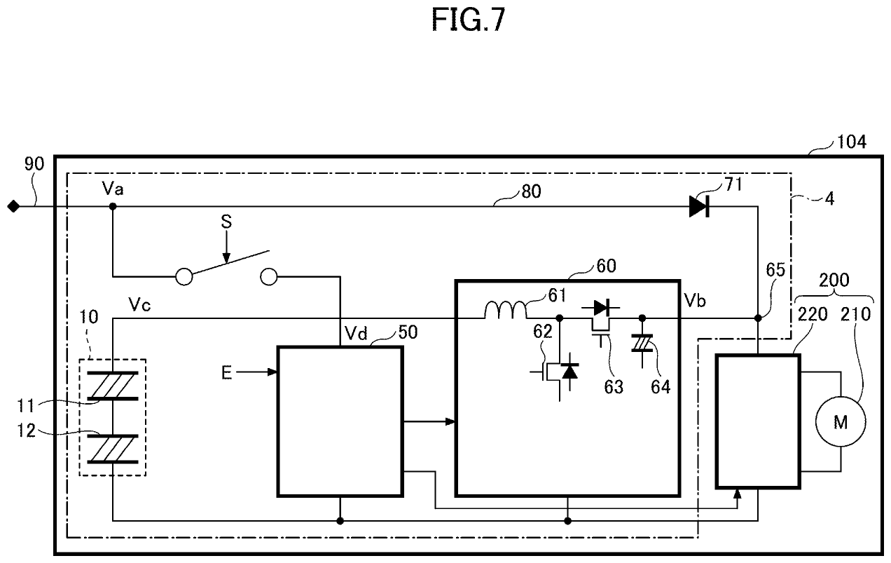

FIG. 7 is a diagram illustrating a configuration example of the motorized device with the power supply device according to a fourth embodiment. In the fourth embodiment, description for the same configuration, operation, and effects as described in the first, second, and third embodiments will be omitted or simplified by incorporating the above description.

A motorized device 104 illustrated in FIG. 7 includes a power supply device 4 and the load device 200. The power supply device 4 differs from that described in the first embodiment in that the power supply device 4 includes a diode 71.

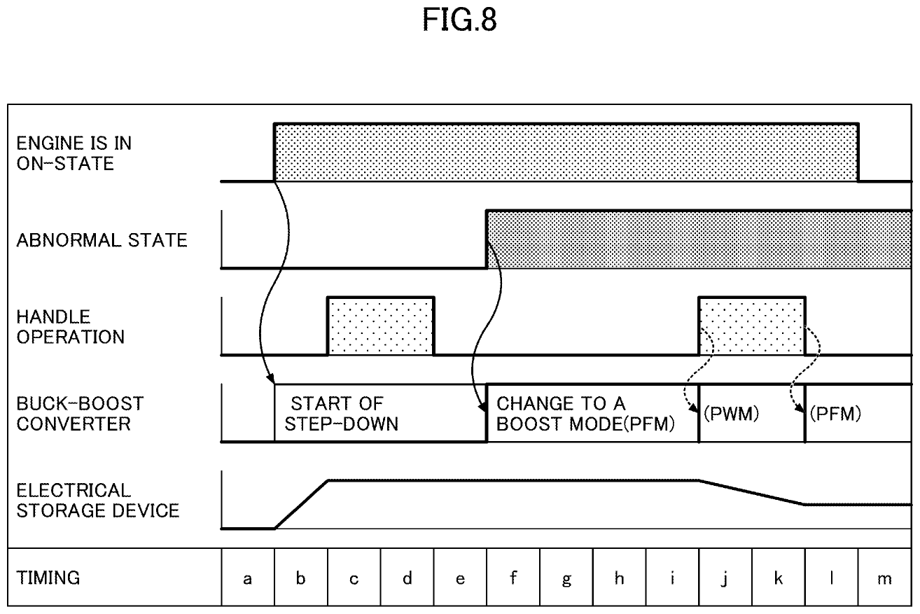

FIG. 8 is a timing chart illustrating an operation example of the power supply device according to the fourth embodiment. In the fourth embodiment, the control circuit 50 starts the bidirectional buck-boost converter 60 in a charge mode immediately after the power is input from the power system 90, and then the control circuit 50 operates the bidirectional buck-boost converter 60 as the buck converter (charging circuit). If the voltage Vc is lower than the first threshold Vth1, the control circuit 50 charges the electrical storage device 10 until the voltage Vc increases to the second threshold Vth2. The voltage Vc of the electrical storage device 10 gradually increases by the charging operation. When the voltage Vc increases to the second threshold Vth2, the control circuit 50 stops the charging operation of the bidirectional buck-boost converter 60.

In the fourth embodiment, at the timing f, upon detecting an abnormality in the vehicle based on the emergency signal E, the control circuit 50 causes the bidirectional buck-boost converter 60 to switch from the charge mode to the boost mode to thereby operate the bidirectional buck-boost converter 60 as the boost converter (boost circuit). When the operation of the vehicle equipment is detected based on the operation detection signal S, the control circuit 50 may cause the bidirectional buck-boost converter 60 to switch from the charge mode to the boost mode to thereby operate the bidirectional buck-boost converter 60 as the boost converter (boost circuit)

In the fourth embodiment, in the normal state, the control circuit 50 operates the bidirectional buck-boost converter 60 in the charge mode. In this arrangement, in the normal state, the power input through the power path 80 can be supplied to both the bidirectional buck-boost converter 60 and the load device 200.

Although the embodiments are described above, the present invention is not limited to the above-described embodiments. Various modifications and improvements, such as combinations with or substitutions of a portion or all of other embodiments, can be made.

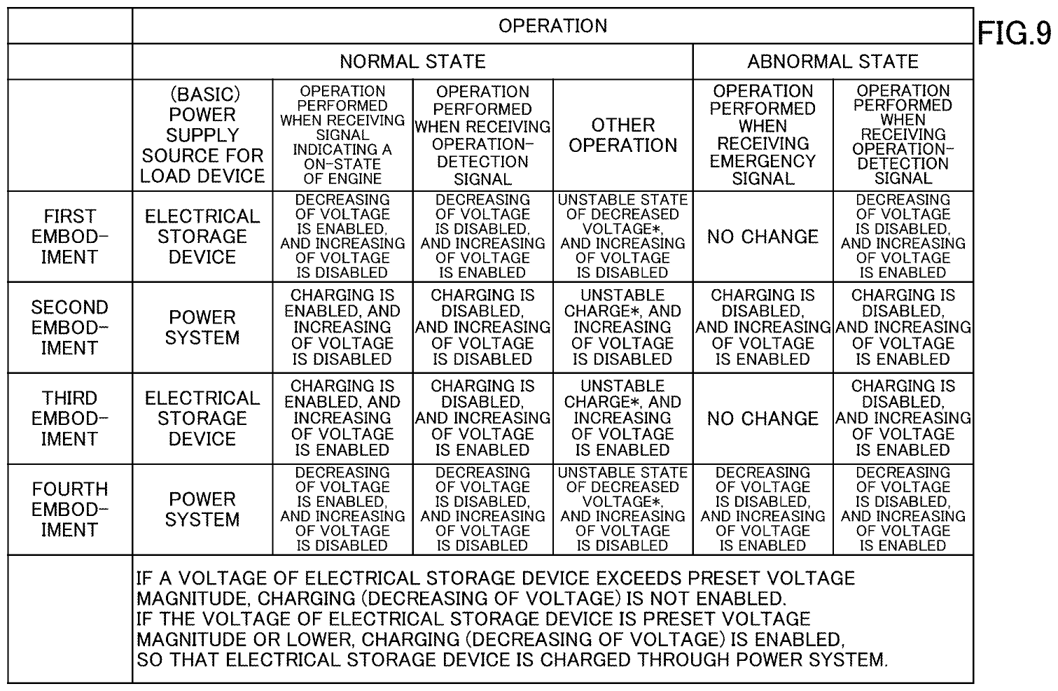

FIG. 9 illustrates a table that summarizes the operation examples described in the embodiments. Each of a case where the decreasing of the voltage is enabled and a case where charging is enabled means that the buck operation (charging operation) is performed. Each of a case where the decreasing of the voltage is disabled and a case where charging is disabled means that the buck operation (charging operation) is stopped. A case where the increasing of the voltage is enabled means that the boost operation is performed, and a case where the increasing of the voltage is disabled means that the boost operation is stopped.

The international application claims priority to Japanese Patent Application No. 2021-108417, filed on Jun. 30, 2021, the entire contents of which are incorporated herein by reference.

### REFERENCE SIGNS LIST

1, 2, 3, 4 power supply device
10 electrical storage device
11, 12 cell
20 charging circuit
30 boost circuit
40 equalization circuit
41, 42 resistor
50 control circuit
51 regulator
52 diode
60 bidirectional buck-boost converter
65 output node
71, 72 diode
80 power path
81 backflow prevention circuit
82 overcurrent prevention circuit
83 resistor
90 power system
101, 102, 103, 104 motorized device
200 load device
210 load
220 drive circuit

1. A power supply device comprising:
an electrical storage device;
a charging circuit configured to
start charging of the electrical storage device based on input power from a power system of a vehicle, upon occurrence of a condition in which a voltage of the electrical storage device decreases to a first threshold, and
stop the charging of the electrical storage device, upon occurrence of a condition in which the voltage of the electrical storage device increases to a second threshold, the second threshold being greater than the first threshold;
a boost circuit configured to step up the voltage of the electrical storage device; and
a control circuit configured to cause the boost circuit to perform a boost operation such that,
a boosted voltage that is higher than the voltage of the electrical storage device is supplied to a load device, and
the boosted voltage is a constant voltage.

2. The power supply device according to claim 1, further comprising:
a power path with one end coupled to the power system and the other end coupled to an output node side of the boosted voltage.

3. The power supply device according to claim 2, wherein the boost circuit is a bidirectional buck-boost converter that includes the charging circuit.

4. The power supply device according to claim 3, wherein the control circuit is configured to cause the bidirectional buck-boost converter to perform a charging operation such that the electrical storage device is charged with power that is input from the output node through the power path.

5. The power supply device according to claim 4, wherein the control circuit is configured to
cause the bidirectional buck-boost converter to perform the charging operation upon occurrence of the condition in which the voltage of the electrical storage device decreases to the first threshold, and
stop the charging operation of the bidirectional buck-boost converter upon occurrence of the condition in which the voltage of the electrical storage device increases to the second threshold.

6. The power supply device according to claim 3, wherein the load device is a device configured to control an operation of vehicle equipment that is operated by a user, and
wherein the control circuit is configured to cause the bidirectional buck-boost converter to perform the boost operation, while the vehicle equipment is operated.

7. The power supply device according to claim 6, wherein the control circuit is configured to stop the boost operation of the bidirectional buck-boost converter, in a case where the vehicle equipment is not operated.

8. The power supply device according to claim 3, wherein the control circuit is configured to cause the bidirectional buck-boost converter to switch from a charge mode to a boost mode, upon occurrence of a condition in which an abnormality in the vehicle is detected.

9. The power supply device according to claim 3, wherein the load device is a device configured to control an operation of vehicle equipment that is operated by a user,
wherein the control circuit is configured to cause the bidirectional buck-boost converter to switch from a charge mode to a boost mode, upon occurrence of a condition in which the operation of the vehicle equipment is detected.

10. The power supply device according to claim 2, wherein the control circuit is configured to operate the boost circuit such that the boosted voltage is lower than a voltage of the power path.

11. The power supply device according to claim 10, wherein the control circuit is configured to start, upon occurrence of a condition in which an abnormality in the vehicle is detected, the boost operation of the boost circuit such that a current flows from the boost circuit into the load device.

12. The power supply device according to claim 11, wherein the load device is a device configured to control an operation of vehicle equipment that is operated by a user, and
wherein the control circuit is configured to
operate, upon occurrence of the condition in which the abnormality in the vehicle is detected, the boost circuit intermittently or in a PFM operating mode, and
cause the boost circuit to switch to a PWM operating mode, upon occurrence of a condition in which the operation of the vehicle equipment is detected.

13. The power supply device according to claim 1, wherein the load device is a device configured to control an operation of vehicle equipment that is operated by a user, and
wherein in a case where the control circuit causes the boost circuit to perform the boost operation such that a current flows from the boost circuit into the load device, the control circuit is configured to
cause the boost circuit to switch from the boost operation to either an intermittent operation or a PFM operating mode, upon occurrence of a condition in which an abnormality in the vehicle is detected, and
after the switching, cause the boost circuit to switch from the boost operation to a PWM operating mode, upon occurrence of a condition in which the operation of the vehicle equipment is detected.

14. The power supply device according to claim 1, further comprising:
a regulator configured to generate a supply voltage to the control circuit, based on the power that is supplied by either the power system or the electrical storage device.

15. The power supply device according to claim 14, further comprising:
a diode in which an anode is coupled to an output side of the electrical storage device and a cathode is coupled to an input side of the regulator.

16. A power supply device comprising:
an electrical storage device;
a charging circuit configured to charge the electrical storage device based on input power from a power system of a vehicle;
a boost circuit configured to step up a voltage of the electrical storage device; and
a control circuit configured to cause the boost circuit to perform a boost operation such that a boosted voltage that is higher than the voltage of the electrical storage device is supplied to a load device as a constant voltage, regardless of whether a failure of the power system or an emergency state occurs.

17. A motorized device comprising:
the power supply device of claim 1; and
the load device.

18. The motorized device according to claim 17, wherein the load device is a device configured to control an operation of vehicle equipment that is operated by a user.

19. The motorized device according to claim 18, wherein the vehicle equipment is an opening-and-closing member.
